(19) United States
(12) Patent Application Publication
(10) Pub. No.: US 2009/0254418 A1
(43) Pub. Date: Oct. 8, 2009

(54) Methods for marketing corporate brands

(76) Inventor: Brenda Bax, Clayton, MO (US)

Correspondence Address: WENDELL RAY GUFFEY;NESTLE PURINA PETCARE GLOBAL RESOURCES, INC., 1 CHECKERBOARD SQUARE, 11-T, ST. LOUIS, MO, 63164, US

(21) Appl. No.: 12/384,031

(22) Filed: Mar. 31, 2009

Related U.S. Application Data
(60) Provisional application No. 61/072,755, filed on Apr. 2, 2008.

(51) Int. Cl. G06Q 30/00

(52) U.S. Cl. 705/10; 705/14

(57) ABSTRACT

Business methods are provided for marketing and increasing sales of corporate products or brands by collecting information about one or more animal welfare organizations, collecting information from one or more consumers about animal welfare, and processing the animal welfare organization information and the consumer information to design a marketing program executable by the corporation that enables the consumer to interact with the animal welfare organization.

### CROSS REFERENCE TO RELATED APPLICATIONS

This application claims priority to U.S. Provisional Application Ser. No. 61/072,755 filed Apr. 2, 2008, the disclosure of which is incorporated herein by reference.

### BACKGROUND OF THE INVENTION

1. Field of the Invention

The present invention relates generally to marketing and sales and particularly to methods of marketing corporate brands while benefiting consumers and animal welfare organizations.

2. Description of Related Art

Animal welfare organizations (AWO) such as animal shelters and foster groups and similar organizations dedicated to the welfare or benefit of a particular group have had difficulty in achieving sustainable and meaningful relationships with corporations that provide goods and services, e.g., pet food and related services. Such organizations typically engage in and seek corporate support for activities such as increasing public awareness of their cause, fundraising, soliciting and working with volunteers, and managing animal welfare and similar groups. These organizations may have consumers regularly participating in their programs, e.g., adopting, volunteering, donating, and the like, but they have difficulty leveraging or extending their influence with consumers to gain corporate support, e.g., money, goods, or services, because of their limited ability to access and cooperate with corporations. Similarly, corporations have difficulty getting consumers to appreciate their involvement with causes such as animal welfare and their support for organizations that are active in such causes, particularly in a manner that would encourage consumers to purchase particular products and brands because the consumers recognize that corporations support causes that are of interest to the consumer. There is, therefore, a need for methods that encourage corporations and organizations that promote a particular cause to work together in a manner that generates synergistic advantages for the corporation and the organization, particularly to generate corporate support for the organization while increasing brand recognition and marketing corporate brands for the corporation.

### SUMMARY OF THE INVENTION

The present invention is generally directed to methods for marketing and increasing sales of one or more brands. In alternative embodiments, methods of the present invention provide new ways to connect cause-related pet consumers to an AWO-corporation network in an effective and scalable way. For example, the methods allow consumers to actively participate in and influence the AWO-corporation network. Moreover, because of the ability of consumers to actively participate with the AWO-corporation network, the methods provide new avenues for the corporation to market brands of one or more goods and services and positively influence the consumer's loyalty toward the brand.

In a general embodiment, a method for marketing a corporate brand comprises collecting information about at least one AWO, collecting information from at least one consumer about animal welfare, and using or processing the AWO information and/or the consumer information to design a brand marketing program executable by the corporation that enables the consumer to interact with the AWO.

In an embodiment, the information collected from the AWO can be contact information, pet information, personnel, donations, programs, needs, strategies, or combinations thereof.

In an embodiment, the information collected from the consumer is can be personal contact information, pet ownership, needs, preferences, relationship to AWOs, or combinations thereof.

In an embodiment, the marketing program is directed to at least one demographic of the consumer.

In an embodiment, the method is implemented using a computer. In another, the AWO information and consumer information are collected in an electronic database. In an embodiment, the AWO information and consumer information are processed using at least one algorithm. In another, at least one of the AWO information and the consumer information are collected using a computer connected to the internet.

In an embodiment, the consumer interacts with the animal organization information through a website connected to the internet.

In an embodiment, the AWO must meet a specified requirement to be a part of the marketing program.

In an embodiment, the marketing program benefits the AWO by awarding the AWO items such as food coupons, money, free products, discounts for pet adoptions, or combinations thereof.

In an embodiment, the marketing program benefits the AWO by increasing the number of volunteers at the AWO. In an embodiment, the marketing program benefits the AWO by increasing the number of animal adoptions at the AWO. In an embodiment, the marketing program benefits the AWO by increasing the number of donations to the AWO.

In an embodiment, the marketing program benefits the corporation by increasing marketing opportunities for the corporation.

In another embodiment, the present invention provides a method for improving animal welfare. The method comprises collecting information about at least one AWO in a database, collecting information from at least one consumer about animal welfare in the database, processing the AWO information and the consumer information to design marketing programs for a corporation, and rewarding the AWO based on a performance of the marketing program.

In an embodiment, the method further comprises rewarding the AWO based on the association of a marketed brand of the corporation with the AWO.

In an embodiment, the AWO must meet a specified requirement to be a part of the marketing program.

In an alternative embodiment, the present invention provides a method of increasing interaction between a consumer and an AWO. The method comprises providing a data gathering and distribution device operated by a corporation, entering information into the device about at least one AWO on the device, entering information into the device from at least one consumer about animal welfare, and generating a marketing program on the device to allow the consumer to interact with the AWO.

In an embodiment, the data gathering and distribution device is a computer connected to the internet.

In yet another embodiment, the present invention provides a method for generating revenue for a corporation. The method comprises collecting information about at least one AWO, collecting information from at least one consumer about animal welfare, and processing the AWO information and consumer information to design a marketing program for a corporate brand. One or more products or services of the corporation can be sold pursuant to the marketing program.

An advantage of the present invention is to provide an improved method for marketing a brand of goods or services. Another advantage of the present invention is to provide an improved method of building brand loyalty. Yet another advantage of the present invention is to provide an improved method of generating sales for a corporate brand. Still another advantage of the present invention is to provide a method of improving an AWO. Yet another advantage of the present invention is to provide a method of increasing interaction between a consumer and an AWO.

Other and further objects, features, and advantages of the present invention will be readily apparent to those skilled in the art.

### DETAILED DESCRIPTION OF THE INVENTION

The term “AWO” means animal welfare organizations such as animal shelters, foster groups, and similar organizations formed for the welfare or benefit of animals.

The term “corporate brand” means the use of the name of a corporation (for-profit or not-for-profit), partnership, individual, or other business or legal entity to identify or associate with one or more brands or products marketed by such entity.

The term “corporation” is used in a broad sense to include any organization that sells or markets products or services whether or not they are incorporated as that term may be used in a legal sense. Thus, corporations include, by way of example, corporations, companies, partnerships, individuals, doing business as (dba) organizations, associations, AWOs (if working with other AWOs), and the like.

In the aspects and embodiments, the invention provides for AWOs to function as a corporation as the term is used herein and promote their brands. In these aspects and embodiments, the terms AWO and corporation as used herein are interchanged.

The present invention is generally directed to methods for marketing and increasing sales of one or more corporate brands.

Sometimes, a corporation may view animal welfare as an “added” responsibility and not as a priority and devote few resources to assisting AWOs. Corporations usually assist AWOs by direct monetary donations. Because AWOs are diverse, fragmented, and limited in their abilities to benefit corporations, corporations do not seem to find cooperating with them as a cause warranting the expense of dedicating corporate resources (AWOs alone number beyond 10,000 in the United States) other than money. Corporations may also have an inability to readily connect to and communicate with animal welfare and subsequently related pet consumers on a scalable level.

In alternative embodiments, the methods of the present invention provide additional ways for corporations to benefit from assisting an AWO by having the corporations set up and coordinate marketing programs for corporate brands. These marketing programs run by the corporations allow consumers to directly interact with the AWO. The consumers can also actively and directly participate in a way that benefits the AWO and the corporation. When this happens, the corporation is more readily connected to the motivations and behaviors of the consumer and the motivations and behaviors of the AWO. As a result, corporations can benefit from consumer good will as corporate brands are advertised during the marketing programs to assist the AWO.

In a general embodiment, the method for marketing a brand of the corporation comprises collecting information about at least one AWO, collecting information from at least one consumer about animal welfare, and processing the AWO information and/or the consumer information to design a brand marketing program executable by the corporation that enables the consumer to interact with the AWO.

The AWO information and consumer information can be collected electronically or manually (e.g., by hand). The consumer can be the type of person concerned with animal welfare. The corporation can be a pet food manufacturing corporation. The marketing program can be directed to one or more demographics of the consumer. The marketing program can be computer-based or based on operations or activities not requiring the use of a computer.

In an embodiment, the method is implemented using a computer. For example, the AWO information and consumer information can be collected in an electronic database. The AWO information and consumer information can be processed using at least one algorithm (e.g., run by software) developed to analyze the AWO information and consumer information and produce an appropriate marketing program executable by the corporation for the benefit of the AWO and/or the consumer.

In another embodiment, the AWO information and/or the consumer information can be collected using a computer (e.g., via one or more websites) connected to the internet. For example, the connection between the corporation and the AWO can be built via an on-line portal. A series of algorithms can be built from this on-line portal to reach and communicate with consumers in a multi-dimensional way creating a “triangulation” of communication among the consumer, AWO and corporation. The “triangulation” can allow consumers to contribute ideas and information and preferences that make the AWOs work with the corporation more effective. It also makes the corporation's cooperation with the AWO more visible to consumers, thereby increasing the opportunity to influence the consumer's brand loyalty.

Information can be collected from the AWO and the consumer in any suitable manner. For example, the information can be collected using a data gathering device (e.g., computer) that collects information about one or more AWOs and consumers. The type of information collected from the AWO can be, for example, contact information (e.g., name and address), pet information (e.g., types, numbers), personnel, donations (e.g., how much, how often), programs, needs, strategies (e.g., organizational structure), or combinations thereof. The types of information collected from the consumer can be, for example, personal contact information, pet ownership (e.g., how many, how long), needs, preferences, relationship to AWOs, and combinations thereof.

The data gathering device can communicate the data to one or more databases. The database can be readable by a computer program that runs an algorithm on the data to determine the brand marketing program(s) that are beneficial for the AWO based on the information collected from the AWO and the consumer (e.g., the brand marketing program can utilize a pet adoption program for an AWO, particularly if the shelter is in a senior demographic area).

In an embodiment, the AWO must meet a specified requirement to be a part of the marketing program. For example, the AWO may be required to regularly enter information and data to demonstrate that they are performing in accordance with marketing program parameters. The AWO can get rewarded based upon their performance (e.g., food coupons, money, discount for adoptions, etc.). The brand marketing program of the corporation can further benefit the AWO by increasing the number of volunteers at the AWO, by increasing the number of animal adoptions at the AWO, and/or by increasing the number of donations to the AWO.

In an embodiment, the brand marketing program benefits the corporation by increasing marketing opportunities for the corporation. For example, the marketing program can utilize a data distribution and gathering device (e.g., computer website) that allows the consumer to review information about the collaborative work between the AWO and corporation. The consumer can then elect to participate (possibly on multiple levels) and interact with the AWO by clicking on different interactive links of the website (e.g., clicking on a link to show support, clicking on a link to send a note of thanks or a note of gratitude to the AWO and its staff, submitting their name and zip code and post pet story, taking a survey about animal welfare, submitting requests for the AWO-corporation network, etc.).

The corporation can also take the information collected from the AWO and the consumer and process it to determine a marketing program that is best suited to for specific purposes such as to generate donations, volunteers, and/or adoptions for the AWO or pet cause. Non-limiting examples of the interactive marketing programs directed to the consumer and developed and executed by the corporation (e.g., based on the AWO information and/or the consumer information) to allow the consumer to actively interact with the AWO can be based on the following:
Purchasing a song online where the proceeds can be donated to the AWO
Providing all the artwork to host a birthday party at a consumer's home or at an AWO with “reverse” goodie bags where guests bring bags of commodities needed to run a shelter
Hosting a lemonade stand in a consumer's neighborhood with the proceeds going to the local shelter
Hosting a pet cause carwash/petwash
Texting a message of hope or thanks to an AWO text line
Hosting a campaign such as a “pet lovers week” at a retail store where families are inspired to take their pets because the store is a supporter of pets and pet families and this action helps the community see pets elevated in life
Requesting a corporation to host a “matching volunteer” program where the corporation will match their donation hours with a specific amount of money per volunteer hour if a pet family volunteers with a pet cause
Inspiring a movie night or library night with pets where pet families work with local movie theatres or libraries to establish a once per month take-your-pet-to-movie/library day
Inspiring physicians to consider pet therapy as a holistic way to achieve therapy progress in a patient
Matching “visiting pet families” with people in need to facilitate pet care for people
Establishing on-line mentors to guide pet selection and family activities and community pet sitting swaps
Providing on-line games to drive donations to AWO
Calling a toll free number to give a show of support to AWO volunteers and staff
Spreading a message via email or invite others to participate in the AWO movement
Providing campaign trend shows such as a talent contest or reality based television show that includes a pet angle with a pet theme
Providing a “how-to guide” to work with a local retailer to host a “pet lovers” day or pet lovers promotion at their store, etc., with all the donations and volunteer interests going to the shelter

The methods in alternative embodiments of the present invention can increase the brand loyalty to the corporation sponsoring the programs. For example, the consumer would recognize a corporation's interest in animal welfare and the corporation's support for AWOs. Based upon this recognition, the consumer would favor the corporation's brands. The methods can also increase and improve animal welfare by increasing awareness of the plight of homeless animals and increasing support, monetary and otherwise, for AWOs. In another embodiment, the marketing program can further benefit the consumer by rewarding the consumer with prizes such as food coupons, money, free products, discounts for pet adoptions, and combinations thereof.

In another embodiment, the present invention provides a method for improving animal welfare. The method comprises collecting information about at least one AWO in a database, collecting information from at least one consumer about animal welfare in the database, processing the AWO information and the consumer information to design marketing programs for a corporation, and rewarding the AWO based on a performance of the marketing program. The method can further comprise rewarding the AWO based on the association of a marketed brand of the corporation with the AWO.

In an alternative embodiment, the present invention provides a method of increasing interaction between a consumer and an AWO. The method comprises providing a data gathering and distribution device operated by a corporation, entering information into the device about at least one AWO on the device, entering information into the device from at least one consumer about animal welfare, and generating a marketing program on the device to allow the consumer to interact with the AWO. The data gathering and distribution device can be a computer connected to the internet.

In yet another embodiment, the present invention provides a method for generating revenue for a corporation. The method comprises collecting information about at least one AWO, collecting information from at least one consumer about animal welfare, and processing the AWO information and consumer information to design a marketing program for a corporate brand. Products or services of the corporation can be sold pursuant to the marketing program. The marketing program can provide the consumer one or more opportunities to directly interact with and assist in benefiting the AWO. The brand of the corporation can be advertised/sold as part of the marketing program. The increase in brand exposure will lead to an increase in sales of the brand thereby generating revenue for the corporation.

In another aspect, the invention provides a software program capable of implementing one or more methods for or one or more steps in the methods for (1) marketing a corporate brand comprising collecting information about at least one animal welfare organization, collecting information from at least one consumer about animal welfare, and using at least one of the animal welfare organization information and the consumer information to design a brand marketing program executable by the corporation that enables the consumer to interact with the animal welfare organization; (2) improving animal welfare comprising collecting information about at least one animal welfare organization in a database, collecting information from at least one consumer about animal welfare in the database, using the animal welfare organization information and the consumer information to design a marketing program for a corporation, and rewarding the animal welfare organization based on a performance of the marketing program; (3) A method for improving animal welfare comprising collecting information about at least one animal welfare organization in a database, collecting information from at least one consumer about animal welfare in the database, using the animal welfare organization information and the consumer information to design a marketing program for a corporation, and rewarding the animal welfare organization based on a performance of the marketing program; (4) generating revenue for a corporation comprising collecting information about at least one animal welfare organization, collecting information from at least one consumer about animal welfare, processing the animal welfare organization information and consumer information to design a marketing program for a corporate brand, and selling a products or a service pursuant to the marketing program; or (5) marketing a corporate brand comprising collecting information about at least one animal welfare organization through a first website connected to an internet, collecting information from at least one consumer about animal welfare through a second website connected to the internet, and processing the animal welfare organization information and the consumer information on a central computer processor to design a brand marketing program executable by the corporation that enables the consumer to interact with the animal welfare organization through the internet. In another aspect, the invention provides a computer or equivalent device capable of running software comprising the software of the present invention. In one embodiment, the methods comprise processing animal welfare organization information and consumer information using at least one algorithm. In another, the methods comprise collecting at least one of the animal welfare organization information and the consumer information using a computer connected to the internet.

In another aspect, the invention provides a means for communicating information about or instructions for one or more of (1) marketing a corporate brand comprising collecting information about at least one animal welfare organization, collecting information from at least one consumer about animal welfare, and using at least one of the animal welfare organization information and the consumer information to design a brand marketing program executable by the corporation that enables the consumer to interact with the animal welfare organization; (2) improving animal welfare comprising collecting information about at least one animal welfare organization in a database, collecting information from at least one consumer about animal welfare in the database, using the animal welfare organization information and the consumer information to design a marketing program for a corporation, and rewarding the animal welfare organization based on a performance of the marketing program; (3) A method for improving animal welfare comprising collecting information about at least one animal welfare organization in a database, collecting information from at least one consumer about animal welfare in the database, using the animal welfare organization information and the consumer information to design a marketing program for a corporation, and rewarding the animal welfare organization based on a performance of the marketing program; (4) generating revenue for a corporation comprising collecting information about at least one animal welfare organization, collecting information from at least one consumer about animal welfare, processing the animal welfare organization information and consumer information to design a marketing program for a corporate brand, and selling a products or a service pursuant to the marketing program; (5) marketing a corporate brand comprising collecting information about at least one animal welfare organization through a first website connected to an internet, collecting information from at least one consumer about animal welfare through a second website connected to the internet, and processing the animal welfare organization information and the consumer information on a central computer processor to design a brand marketing program executable by the corporation that enables the consumer to interact with the animal welfare organization through the internet; (6) using the software of the present invention, or (7) using a computer or equivalent device comprising the software of the present invention. The means comprises a document, digital storage media, optical storage media, audio presentation, or visual display containing the information or instructions. In certain embodiments, the communication means is a displayed web site, visual display kiosk, brochure, product label, package insert, advertisement, handout, public announcement, audiotape, videotape, DVD, CD-ROM, computer readable chip, computer readable card, computer readable disk, computer memory, or combination thereof containing such information or instructions. The communication means is useful for instructing on the benefits of using the present invention and communicating the benefits of methods for increasing brand loyalty and marketing corporate brands.

### EXAMPLES

The invention can be further illustrated by the following examples, although it will be understood that these examples are included merely for purposes of illustration and are not intended to limit the scope of the invention unless otherwise specifically indicated.

### Example 1

Information (i.e., data) gathered from an AWO:
AWO intakes 20,000 pets annually
AWO is open admission shelter (“kill” shelter)
Staff has significant presence of passion fatigue
Management has passion fatigue program for staff
AWO has staff email capability
AWO gets limited positive reinforcement from pet owners

Information (i.e., data) gathered from a consumer:
Consumer has dog
Consumer says yes to those questions that identify the consumer as a “segment A” type of dog owner (owners in this segment have a pet relationship based on the need to nurture)

This information is processed and, based on this information, the following needs were identified:
AWO needs more positive feedback from pet owners
Consumer has a need to feel that they are nurturing their pet and the pet community

Based on the needs of the AWO and the consumer, the following marketing program was developed and executed:
A “Send a Note of Thanks and Appreciation” program
This program allows the consumer to open a tool on-line, create a message of positive reinforcement and validation to the AWO staff, select the local AWO email address and a staff member, and send an email or “hope note” as additional positive reinforcement

This program is identified as “powered by” Corporation1 (meaning a Corporate Name) so that consumers understand that the program is funded by the profits of Corporation1 and that, when they purchase products sold by Corporation1, they are helping to establish and sustain programs like this program that acknowledge the volunteers and staff that attend to the most serious situations for pets. Also, to participate and get the benefits of this program, the AWO must feed and recommend Corporation1 products.

### Example 2

Information gathered from AWO:
AWO intakes 20,000 pets annually
AWO has continuous need for donations
AWO has limited children's donation programs

Information gathered from consumer:
Consumer has 1 dog and 2 cats
Consumer has 2 kids in elementary school
Consumer likes to spend time with kid's school, kid's sports, and scrap booking
Consumer is inclined to become involved in community service

This information is processed and, based on this information, the following needs were identified:
The AWO can benefit from a children's program inspiring donations of cleaning products and cash
The consumer can benefit from child oriented community service

Based on the needs of the AWO and consumer, the following marketing program was developed and executed:
A help homeless pet lemonade stand
This program allows the consumer to download “help homeless pet” stickers and print out a “Help Homeless Pet” banner (styled in fun and engaging art). The consumer sets up lemonade stand with banner and “sells” lemonade and/or “I Helped A Homeless Pet Today” stickers. The consumer facilitates the child to collect donations and bring the donations to the AWO.

This program is identified as “powered by” Corporation1 so that consumers understand that the program is funded by the profits of Corporation1 and that, when they purchase products sold by Corporation1, they are helping to establish and sustain programs like this program. Also, to participate and get the benefits of this program, the AWO must feed and recommend Corporation1 products.

### Example 3

Information gathered from AWO:
AWO intakes 20,000 pets annually
AWO has continuous need for donations
AWO has limited teen engagement programs

Information gathered from consumer:
Consumer has 2 dogs
Consumer has 1 kid in college, 1 teen in high school
Teen and consumer are regular purchasers of songs online

This information is processed and, based on this information, the following needs were identified:
The AWO can benefit from teen engagement program
The consumer can benefit from purchasing songs online and also help a cause

Based on the needs of the AWO and the consumer, the following marketing program was developed and executed:
A “Purchase a Song Online and Save a Pet” campaign
Corporation1 contracts with another entity to offer songs for purchase, where a portion of proceeds from purchased songs are directed as a donation to the “fund” within the Save A Pet campaign. This fund is managed on-line where teens can watch how many donations were generated and where the donations were directed.

This program is identified as “powered by” Corporation1 so that consumers understand that the program is funded by the profits of Corporation1 and that, when they purchase products sold by Corporation1, they are helping to establish and sustain programs like this program. Also, to participate and get the benefits of this program, the AWO must feed and recommend Corporation1 products.

### Example 4

Information gathered from AWO:
AWO intakes 20,000 pets annually
AWO has continuous need for donations and volunteers
AWO has limited teen engagement programs

Information gathered from consumer:
Consumer has 2 cats
Consumer has 2 teens in high school
Family is a frequent user of local Corporation2

This information is processed and, based on this information, the following needs were identified:
The AWO can benefit from teen engagement programs with volunteerism and donation
The consumer can benefit from having Corporation2 spending extend to helping a cause

Based on the needs of the AWO and consumer, the following marketing program was developed and executed:
A “Pet Lovers” campaign
Corporation1 works with Corporation2 to direct staff to participate in “donation and volunteer match” program to be directed to animal welfare. This program encourages Corporation2 patrons to bring along a roll of paper towels when you come for your coffee as donation to local shelter—Corporation2 will match the value of donation. It also encourages patrons and baristas to identify themselves as pet lovers (download “I love that Corporation2 love pets!” stickers) and inquire with barista about opportunity to join barista for volunteer time at local shelter. Corporation2 program matches volunteer time at $10/hour.

This program is identified as “powered by” Corporation1 so that consumers understand that the program is funded by the profits of Corporation1 and that, when they purchase products sold by Corporation1, they are helping to establish and sustain programs like this program. Also, to participate and get the benefits of this program, the AWO must feed and recommend Corporation1 products.

In the specification, there have been disclosed typical preferred embodiments of the invention. Although specific terms are employed, they are used in a generic and descriptive sense only and not for purposes of limitation, e.g., “Corporation1” and “Corporation2.” The scope of the invention is set forth in the claims. Obviously many modifications and variations of the invention are possible in light of the above teachings. It is therefore to be understood that within the scope of the appended claims the invention may be practiced otherwise than as specifically described.

What is claimed is:

1. A method of marketing a corporate brand comprising:
collecting information about at least one animal welfare organization;
collecting information from at least one consumer about animal welfare; and
using at least one of the animal welfare organization information and the consumer information to design a brand marketing program executable by the corporation that enables the consumer to interact with the animal welfare organization.

2. The method of claim 1 wherein the information collected from the animal welfare organization is selected from the group consisting of contact information, pet information, personnel, donations, programs, needs, strategies, and combinations thereof.

3. The method of claim 1 wherein the information collected from the consumer is selected from the group consisting of personal contact information, pet ownership, needs, preferences, relationship to animal welfare organizations, and combinations thereof.

4. The method of claim 1 wherein the marketing program is directed to at least one demographic of the consumer.

5. The method of claim 1 wherein the method is implemented using a computer.

6. The method of claim 1 wherein the animal welfare organization information and consumer information are collected in an electronic database.

7. The method of claim 1 wherein the animal welfare organization information and consumer information are processed using at least one algorithm.

8. The method of claim 1 wherein at least one of the animal welfare organization information and the consumer information are collected using a computer connected to the internet.

9. The method of claim 8 wherein the consumer interacts with the animal organization information through a website connected to the internet.

10. The method of claim 1 wherein the animal welfare organization must meet a specified requirement to be a part of the marketing program.

11. The method of claim 1 wherein the marketing program benefits the consumer by rewarding the consumer with prizes selected from the group consisting of food coupons, money, free products, discounts for pet adoptions, and combinations thereof.

12. The method of claim 1 wherein the marketing program benefits the animal welfare organization by increasing one or more of the number of volunteers at the animal welfare organization, the number of animal adoptions at the animal welfare organization, and the number of donations to the animal welfare organization.

13. The method of claim 1 wherein the marketing program benefits the corporation by increasing marketing opportunities for the corporation.

14. A method for improving animal welfare comprising:
collecting information about at least one animal welfare organization in a database;
collecting information from at least one consumer about animal welfare in the database;
using the animal welfare organization information and the consumer information to design a marketing program for a corporation; and
rewarding the animal welfare organization based on a performance of the marketing program.

15. The method of claim 14 further comprising rewarding the AWO based on the association of a marketed brand of the corporation with the AWO.

16. The method of claim 14 wherein the animal welfare organization must meet a specified requirement to be a part of the marketing program.

17. A method of increasing interaction between a consumer and an animal welfare organization comprising:
providing a data gathering and distribution device operated by a corporation;
entering information into the device about at least one animal welfare organization on the device;
entering information into the device from at least one consumer about animal welfare; and
generating a marketing program on the device to allow the consumer to interact with the animal welfare organization.

18. The method of claim 17 wherein the data gathering and distribution device is a computer connected to the internet.

19. The method of claim 17 wherein the marketing program is designed to generate one or more of donations to the animal welfare organization, volunteers for the animal welfare organization, and animal adoptions for the animal welfare organization.

20. A method of marketing a corporate brand comprising:
collecting information about at least one animal welfare organization through a first website connected to an internet;
collecting information from at least one consumer about animal welfare through a second website connected to the internet; and
processing the animal welfare organization information and the consumer information on a central computer processor to design a brand marketing program executable by the corporation that enables the consumer to interact with the animal welfare organization through the internet.
